(19) United States
(12) Patent Application Publication
(10) Pub. No.: US 2025/0085115 A1
(43) Pub. Date: Mar. 13, 2025

(54) TRANSFORMER FRAMEWORK FOR TRAJECTORY PREDICTION

(71) Applicant: TuSimple, Inc., SAN DIEGO, CA (US)

(72) Inventors: Hao XIAO, San Diego, CA (US); Yiqian GAN, San Diego, CA (US); Ethan ZHANG, San Diego, CA (US); Xin YE, San Diego, CA (US); Yizhe ZHAO, San Diego, CA (US); Zhe HUANG, San Diego, CA (US); Lingting GE, San Diego, CA (US); Robert August ROSSI, JR., San Diego, CA (US)

(21) Appl. No.: 18/501,362

(22) Filed: Nov. 3, 2023

Related U.S. Application Data
(60) Provisional application No. 63/582,422, filed on Sep. 13, 2023.

(51) Int. Cl. G01C 21/30

(52) U.S. Cl. CPC G01C 21/30

(57) ABSTRACT

A computer-implemented method of trajectory prediction includes obtaining a first cross-attention between a vectorized representation of a road map near a vehicle and information obtained from a rasterized representation of an environment near the vehicle by processing through a first cross-attention stage; obtaining a second cross-attention between a vectorized representation of a vehicle history and information obtained from the rasterized representation by processing through a second cross-attention stage; operating a scene encoder on the first cross-attention and the second cross-attention; operating a trajectory decoder on an output of the scene encoder; obtaining one or more trajectory predictions by performing one or more queries on the trajectory decoder.

### CROSS-REFERENCE TO RELATED APPLICATIONS

This application claims priority to and the benefit of U.S. Provisional Application No. 63/582,422, filed on Sep. 13, 2023. The aforementioned application is incorporated herein by reference in its entirety.

### TECHNICAL FIELD

This document describes techniques for predicting object trajectories in a scene.

### BACKGROUND

In computer-assisted vehicle driving such as autonomous driving, the vehicle moves from a current position to a next position by using information processed by an on-board computer. Users expect the computer-assisted driving operation to be safe under a variety of road conditions.

### SUMMARY

Various embodiments disclosed in the present document may be used to predict trajectories of a vehicle and other objects in the vehicle's environment.

In one example aspect, a method for trajectory prediction includes determining a first cross-attention between a vectorized representation of a road map near a vehicle and information obtained from a rasterized representation of an environment near the vehicle by processing through a first cross-attention stage; determining a second cross-attention between a vectorized representation of a vehicle history and information obtained from the rasterized representation by processing through a second cross-attention stage; operating a scene encoder on the first cross-attention and the second cross-attention; operating a trajectory decoder on an output of the scene encoder; generating one or more trajectory predictions by performing one or more queries on the trajectory decoder.

In another aspect, another computer-implemented method of trajectory prediction includes generating one or more predicted trajectories by operating an encoder-decoder combination. The encoder is configured to: receive a rasterized representation of an environment, a vectorized representation of the environment and a raw sensor data representation of the environment; generate tokens by processing the rasterized representation, the vectorized representation and the raw sensor data representation with a scene encoder. The decoder is configured to determine the one or more predicted trajectories by processing the tones through one or more layers of neural network processing.

In yet another aspect, another computer-implemented method includes a generating a plurality of multi-scale vectorized representation of an environment in which a vehicle is operating; generating a plurality of multi-scale raw sensor data representations of the environment, wherein the raw sensor data is from one or more sensors disposed on the vehicle; operating a neural network encoder-neural network decoder cascade in which the plurality of multi-scale vectorized representation and the plurality of multi-scale raw sensor data are processed to generate tokens that are passed from the neural network encoder to the neural network decoder and one or more trajectory predictions are output from the neural network decoder based on one or more queries.

In yet another aspect, an apparatus for vehicle trajectory prediction is disclosed. The apparatus comprises one or more processors configured to implement any of above-recited method.

In yet another aspect, a computer storage medium having code stored thereon is disclosed. The code, upon execution by one or more processor, causes the processor to implement a method described herein.

The above and other aspects and their implementations are described in greater detail in the drawings, the descriptions, and the claims.

### BRIEF DESCRIPTION OF THE DRAWINGS

FIG. 1 shows a block diagram of an example vehicle ecosystem for autonomous driving technology according to some embodiments of the present document.

FIG. 2 is a flowchart for an example method of trajectory prediction.

FIG. 3 is a flowchart for an example method of trajectory prediction.

FIG. 4. is a flowchart for an example method of trajectory prediction.

FIG. 5 is a block diagram of an example trajectory prediction workflow.

FIG. 6 is a block diagram depiction of an example of a workflow for trajectory determination.

FIG. 7 depicts an example of a transformer encoder-decoder configuration.

FIG. 8 depicts an example of a transformer encoder-decoder configuration.

FIG. 9 depicts an example of a transformer encoder-decoder configuration.

FIG. 10 depicts an example of a transformer encoder-decoder configuration.

FIG. 11 shows an example Multi-Granular TRansformer (MGTR) model that can take multimodal inputs in a multi-granular manner.

FIG. 12 shows an example main architecture of LiDAR-based multi-task network (LidarMultiNet).

FIG. 13 shows an example set of operations associated with a Global Context Pooling (GCP) module.

FIG. 14 illustrates an example second-stage refinement pipeline.

### DETAILED DESCRIPTION

Section headings are used in the present document for ease of cross-referencing and improving readability and do not limit scope of disclosed techniques. Furthermore, various image processing techniques have been described by using examples of self-driving vehicle platform as an illustrative example, and it would be understood by one of skill in the art that the disclosed techniques may be used in other operational scenarios also (e.g., video games, traffic simulation, and other applications where moving vehicles are used).

### 1. INITIAL DISCUSSION

To guarantee safety in the complex autonomous driving environment, predicting the future states of a variety of dynamic agents is critical for scene understanding and decision-making. These dynamic agents may include other automobiles, pedestrians, two-wheelers, and so on. The major challenges of motion forecasting come from (i) interrelated multimodal inputs such as maps, agent history states, and traffic information in different temporal and spatial scales, and (ii) inherently stochastic multimodal agent behaviors.

Existing methods mainly take two different approaches towards multimodal inputs: convolutional neural networks (CNN) methods which render inputs including High Definition (HD) maps, agents history states into rasterized images of color-coded attribute, and graph-structured models that takes vectorized features (e.g., polylines). In both approaches, a certain resolution is chosen to preprocess agent and map features. The resolution needs to be “just right” so that it could capture detailed spatio-temporal information such as map topology, accurate history movements of various agents and it would be too large for limited onboard computation resources. However, pedestrians and vehicles do not share the same resolution requirements as they travel through the map at different speeds and patterns. In a related technology field, the computer vision community developed multi-scale processing, often referred to as “pyramid” techniques with the advantage of gaining a more comprehensive “context” at lower resolutions, which could subsequently inform and enhance processing at finer scales. However, there is no mechanism to use such computer vision techniques for trajectory predictions in a self-driving vehicle scenario.

The techniques disclosed in this document overcome the above-discussed limitations, and others. For example, one advantageous feature relates to the use of a multi-granularity (or a multi-scale) transformer model (MGTR), for motion prediction of heterogeneous traffic agents. Introducing multi-granular encoding of environment features allows for capturing objects of various sizes and velocities that may be in the environment of a vehicle.

Another example improvement relates to the use of raw sensor data during the encoder process. The use of raw sensor data allows a higher precision feature extraction/token formation at the encoder, as is further described herein.

Yet another example improvement relates to the use of point cloud raw data (or camera images) as inputs to the encoder, enabling more reliable and accurate identification and tracking of objects, as is further described in the present document.

The disclosed techniques may be implemented by one or more processors of an autonomous vehicle. Example embodiments of such a vehicle are described in Section 2.

### 2. EXAMPLE VEHICLE ECOSYSTEM FOR AUTONOMOUS DRIVING

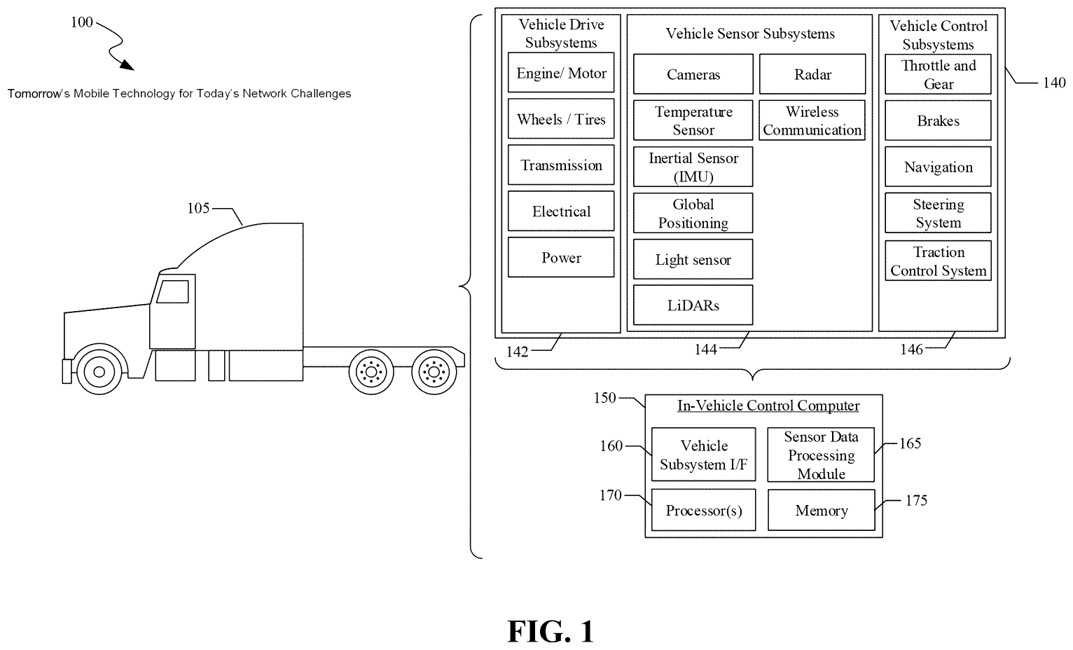

FIG. 1 shows a block diagram of an example vehicle ecosystem 100 for autonomous driving LiDAR technology. The vehicle ecosystem 100 may include an in-vehicle control computer 150 is located in the autonomous vehicle 105. The sensor data processing module 165 of the in-vehicle control computer 150 can perform signal processing techniques on sensor data received from, e.g., one or more of a camera, a light detection and ranging (LiDAR) sensor, a positioning sensor, a radar sensor, an ultrasonic sensor, or a mapping sensor, etc., of (e.g., on or in) the autonomous vehicle 105 so that the signal processing techniques can provide characteristics of objects located on the road where the autonomous vehicle 105 is operated in some embodiments. The sensor data processing module 165 can use at least the information about the characteristics of the one or more objects to send instructions to one or more devices (e.g., motor in the steering system or brakes) in the autonomous vehicle 105 to steer and/or apply brakes.

As exemplified in FIG. 1, the autonomous vehicle 105 may be a truck, e.g., a semi-trailer truck. The vehicle ecosystem 100 may include several systems and components that can generate and/or deliver one or more sources of information/data and related services to the in-vehicle control computer 150 that may be located in an autonomous vehicle 105. The in-vehicle control computer 150 can be in data communication with a plurality of vehicle subsystems 140, all of which can be resident in the autonomous vehicle 105. The in-vehicle computer 150 and the plurality of vehicle subsystems 140 can be referred to as autonomous driving system (ADS). A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The autonomous vehicle (AV) 105 may include various vehicle subsystems that support the operation of the autonomous vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems. Alternatively, in some embodiments, one or more components or devices can be removed from the various subsystems. The vehicle drive subsystem 142 may include components operable to provide powered motion for the autonomous vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment in which the autonomous vehicle 105 is operating or a condition of the autonomous vehicle 105. The vehicle sensor subsystem 144 may include one or more cameras or image capture devices, one or more temperature sensors, an inertial measurement unit (IMU), a Global Positioning System (GPS) device, a plurality of light detection and ranging radar LiDARs, one or more radars, one or more ultrasonic sensors, and/or a wireless communication unit (e.g., a cellular communication transceiver). The vehicle sensor subsystem 144 may also include sensors configured to monitor internal systems of the autonomous vehicle 105 (e.g., an O₂ monitor, a fuel gauge, an engine oil temperature, etc.). In some embodiments, the vehicle sensor subsystem 144 may include sensors in addition to the sensors shown in FIG. 1.

The IMU may include any combination of sensors (e.g., accelerometers and gyroscopes) configured to sense position and orientation changes of the autonomous vehicle 105 based on inertial acceleration. The GPS device may be any sensor configured to estimate a geographic location of the autonomous vehicle 105. For this purpose, the GPS device may include a receiver/transmitter operable to provide information regarding the position of the autonomous vehicle 105 with respect to the Earth. Each of the one or more radars may represent a system that utilizes radio signals to sense objects within the environment in which the autonomous vehicle 105 is operating. In some embodiments, in addition to sensing the objects, the one or more radars may additionally be configured to sense the speed and the heading of the objects proximate to the autonomous vehicle 105. The laser range finders or LiDARs may be any sensor configured to sense objects in the environment in which the autonomous vehicle 105 is located using lasers or a light source. The cameras may include one or more cameras configured to capture a plurality of images of the environment of the autonomous vehicle 105. The cameras may be still image cameras or motion video cameras. The ultrasonic sensors may include one or more ultrasound sensors configured to detect and measure distances to objects in a vicinity of the AV 105.

The vehicle control subsystem 146 may be configured to control operation of the autonomous vehicle 105 and its components. Accordingly, the vehicle control subsystem 146 may include various elements such as a throttle and gear, a brake unit, a navigation unit, a steering system and/or a traction control system. The throttle may be configured to control, for instance, the operating speed of the engine and, in turn, control the speed of the autonomous vehicle 105. The gear may be configured to control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

In FIG. 1, the vehicle control subsystem 146 may also include a traction control system (TCS). The TCS may represent a control system configured to prevent the autonomous vehicle 105 from swerving or losing control while on the road. For example, TCS may obtain signals from the IMU and the engine torque value to determine whether it should intervene and send instruction to one or more brakes on the autonomous vehicle 105 to mitigate the autonomous vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

Many or all of the functions of the autonomous vehicle 105 can be controlled by the in-vehicle control computer 150. The in-vehicle control computer 150 may include at least one processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the autonomous vehicle 105 in a distributed fashion. In some embodiments, the memory 175 may contain processing instructions (e.g., program logic) executable by the processor 170 to perform various methods and/or functions of the autonomous vehicle 105, including those described for the sensor data processing module 165 as explained in this patent document. For example, the processor 170 of the in-vehicle control computer 150 and may perform operations described in this patent document.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 may control the function of the autonomous vehicle 105 based on inputs received from various vehicle subsystems (e.g., the vehicle drive subsystem 142, the vehicle sensor subsystem 144, and the vehicle control subsystem 146).

### 3. BRIEF OVERVIEW OF EXAMPLE METHODS OF TRAJECTORY PREDICTION

This patent document describes an example transformer based motion prediction architecture based on MTR which integrates raw sensor data as an additional input and boosts the prediction performance. In some embodiments, raw sensor data may include lidar point cloud data. In some embodiments, the framework described in this patent document can be applied to camera raw image data.

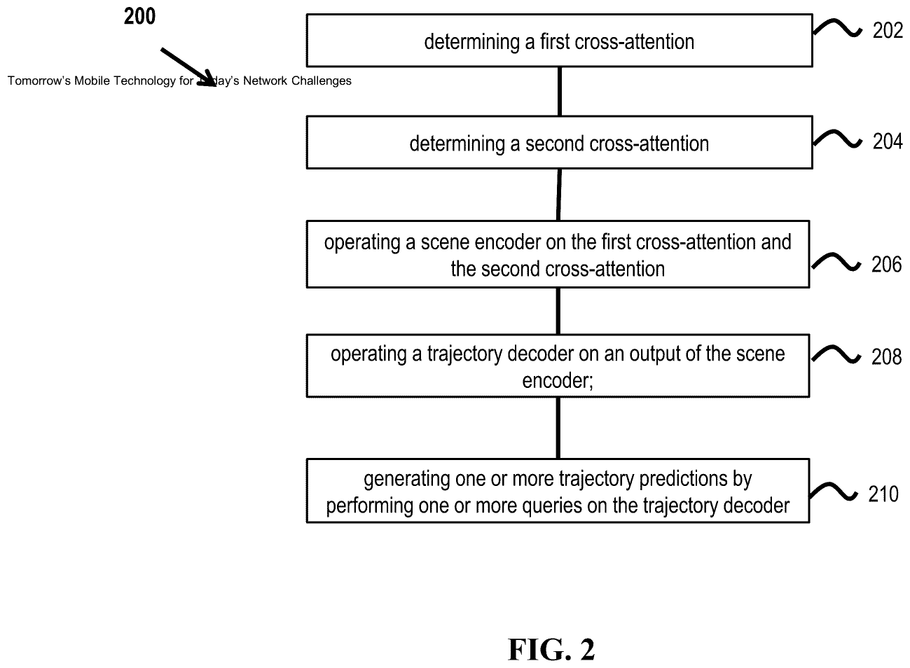

FIG. 2 shows an example method 200 for trajectory prediction. The method 200 includes determining (202) a first cross-attention between a vectorized representation of a road map near a vehicle and information obtained from a rasterized representation of an environment near the vehicle by processing through a first cross-attention stage; determining (204) a second cross-attention between a vectorized representation of a vehicle history and information obtained from the rasterized representation by processing through a second cross-attention stage; operating (206) a scene encoder on the first cross-attention and the second cross-attention; operating (208) a trajectory decoder on an output of the scene encoder; and generating (210) one or more trajectory predictions by performing one or more queries on the trajectory decoder. In some embodiments, the environment near the vehicle may include an area within a known distance (e.g., a pre-determined distance) from the location of the vehicle.

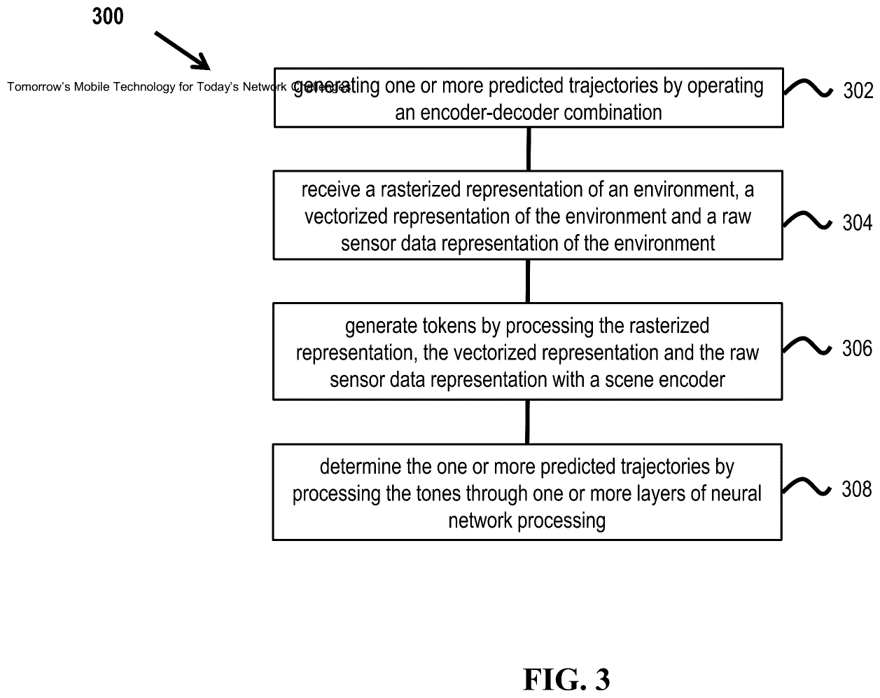

FIG. 3 is a flowchart for a computer-implemented method 300 of trajectory prediction. The method 300 includes generating (302) one or more predicted trajectories by operating an encoder-decoder combination (e.g., an encoder and/or a decoder). The encoder is configured to: receive (304) a rasterized representation of an environment, a vectorized representation of the environment and a raw sensor data representation of the environment; generate (306) tokens by processing the rasterized representation, the vectorized representation and the raw sensor data representation with a scene encoder. The decoder is configured to determine (308) the one or more predicted trajectories by processing the tones through one or more layers of neural network processing.

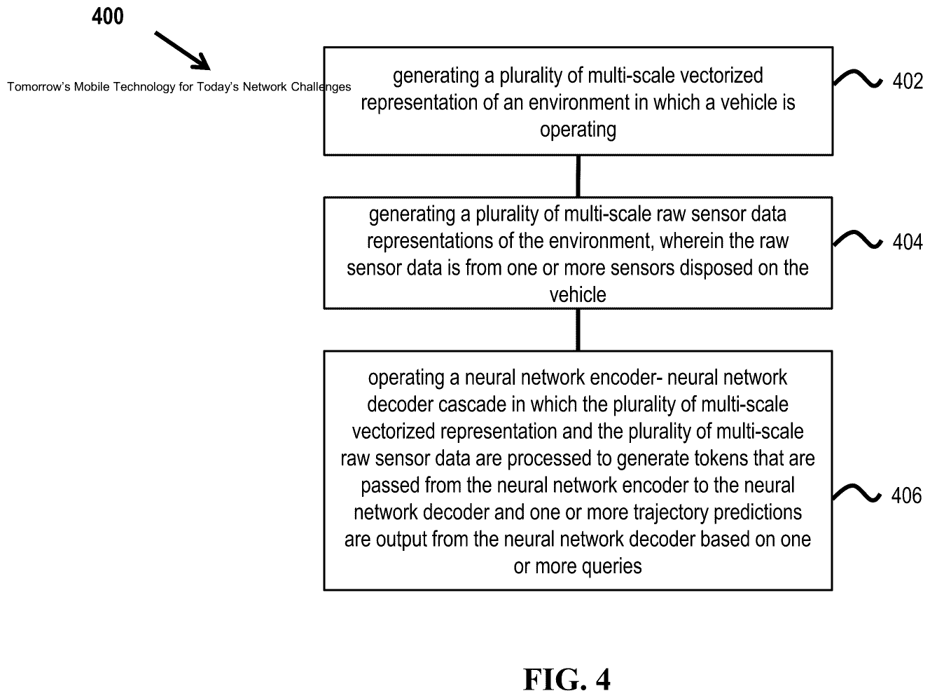

FIG. 4 is a flowchart for a computer-implemented method 400 for predicting trajectories of one or more objects in the environment of a vehicle. The method 400 includes generating (402) a plurality of multi-scale vectorized representation of an environment in which a vehicle is operating; generating (404) a plurality of multi-scale raw sensor data representations of the environment, wherein the raw sensor data is from one or more sensors disposed on the vehicle; and operating (406) a neural network encoder-neural network decoder cascade in which the plurality of multi-scale vectorized representation and the plurality of multi-scale raw sensor data are processed to generate tokens that are passed from the neural network encoder to the neural network decoder and one or more trajectory predictions are output from the neural network decoder based on one or more queries.

The various sections in the present document disclose, among other things, various additional features and techniques that may be incorporated within these methods. The present document also discloses apparatus for implementing the above discloses methods. The present document also discloses computer-storage medium for storing code that, upon execution, causes at least one processor to implement these methods.

### 4. MOTION PREDICTION DISCUSSION

After years of advancement in autonomous driving, motion prediction has become an important building block of success in this field. Accurate motion prediction enables autonomous vehicles to gain insights of future states around their surroundings, which is essential for driving behavior adjustment, risk mitigation and accident avoidance.

Motion prediction can be roughly categorized into two types in terms of model architecture: Convolutional Neural Network (CNN)-based models, and graph neural network (GNN)-based models. CNN-based models usually use rasterized inputs while the later one adopts vectorized data. One embodiment implements an uncertainty-aware model to predict future states of traffic actors. It takes into account a current world state and generated raster images of each traffic agent's vicinity. Such images are then learned by deep convolutional networks to capture uncertainty and infer future movements. One embodiment encodes road information as an image, and use CNN-based encoder-decoder pair to generate future trajectories candidates, and then applied classification and refinement to obtain high quality results. In one example model, i.e., MotionNet, using bird's eye view (BEV) lidar map to encode the environment, and adopted a spatio-temporal pyramid network as backbone for motion behavior of autonomous vehicles' surrounding objects.

To leverage future state-sequence trajectory modes distribution anchors, one embodiment may use a MultiPath model. It estimated the distribution of future trajectories based on top-down scene representation. For each agent, the model cropped its surrounding area and used CNN to extract mid-level features. In recent years, transformer technology has gained more and more attention in the machine learning paradigm due to its scalability and potential in tackling sequential learning tasks. Instead of using dense image-based encoding compared to MultiPath, another embodiment was tried out (called MultiPath++) and used polylines and graphs to efficiently represent environment features to improve efficiency, and used latent representations of anchors to achieve superior performance.

By exploiting structured map information, another embodiments uses the construction of a lane graph from raw map data to extract map features, and introduced graph convolutions to learn interactions between traffic agents and maps. Using multimodal scene data as input, one embodiment put forward a Transformer-based scene encoder and decoder pair to predict multimodal distribution of trajectories. Through GNN, another embodiment integrates perception and motion forecasting using lidar and HD map inputs to produce socially coherent, probabilistic estimates of future trajectory proposed a motion transformer model, i.e., MTR, to predict multimodal future behavior of traffic agents. By introducing learnable motion query, a specific motion mode can be refined, which facilitates better multimodal predictions.

### 5. LIDAR DATA FOR MOTION PREDICTION

Until now, the prohibitively expensive storage requirements for publishing raw sensor data for driving scenes has limited the major motion forecasting datasets. The forecasting relies on abstract representations such as 3D boxes from pre-trained perception models (for objects), polylines (for maps) etc. to represent the driving scenes.

The absence of the raw sensor data leads to the following limitations: 1) Motion forecasting relies on lossy representation of the driving scenes. The human designed interfaces lack the specificity required by the motion forecasting task. For example, the taxonomy of the agent types can be limited to only three types: vehicle, pedestrian, cyclist. However, in certain scenarios some agents might be hard to fit into this taxonomy such as pedestrians on scooters or motor cyclists. Moreover, the fidelity of the input features is quite limited to 3D boxes that hide many important details such as pedestrian postures and gaze directions. 2) Coverage of driving scene representation is centered around where the perception system detects objects. The detection task becomes a bottleneck of transferring information to motion forecasting and planning when the prediction is not sure if an object exists or not, especially in the first moments of an object surfacing. It would be beneficial to enable graceful transmission of information between the systems that is error-robust. 3) Training perception models to match these intermediate representations might evolve them into overly complicated systems that get evaluated on subtasks that are not well correlated with overall system quality.

### 6. MULTI-GRANULARITY (OR MULTI-SCALE) LEARNING

In the real world driving environment, heterogeneous agents have different perception and moving range in a given time period, which brings the necessity of establishing a mechanism to learn such multi-granularity. Some embodiments exploited feature pyramids network (FPN) for object detection, and implied great performance in learning patterns of objects in vastly different scales. The fusion of different scale features brings stronger representational ability of the model.

Another example found that instead of learning on a simple scale, learning at several channel-resolution scale stages can benefit model performance. By creating a multiscale pyramid of features, the model suggested stronger reliance on temporal information. Similarly, in order to predict human motion, a multiscale residual GNN method may be used to extract features from coarse to fine scale. The multi-granularity design may lead to better stability of motion pattern outputs.

Motion prediction is one of the technical components of autonomous driving systems since it can handle highly uncertain and complex scenarios involving moving agents of different types. This patent document proposes a Multi-Granular TRansformer (MGTR) framework, an encoder-decoder network that can exploit context features in different granularities for different kinds of traffic agents. To further enhance MGTR's capabilities, LiDAR point cloud data can be leveraged by incorporating LiDAR semantic features.

### (i). Introduction

High-quality motion prediction in a long horizon may be used to develop safety-critical autonomous vehicles. High-quality motion prediction can be part of scene understanding and/or decision-making in the realm of autonomous driving. Autonomous driving can involve at least the following technical problems: (i) Heterogeneous data acquired by autonomous vehicles such as maps and agent history states can be non-trivial to be represented in a unified space; (ii) environment context inputs from upstream modules including object detection and pre-built maps can have limitations (e.g., uncountable amorphous regions such as bushes, walls, and construction zones, can be missing); (iii) multimodal nature of agent behaviors can bring further complexity. Here, the multimodal agent behaviors can refer to discrete and diverse agent intents and possible futures. This patent document describes solutions that can addresses at least these technical problems using, for example, a multi-granular Transformer model or MGTR. MGTR can be used for motion prediction of heterogeneous traffic agents.

MGTR can follow a Transformer encoder-decoder architecture. It may fuse multimodal inputs including agent history states, map elements, and extra 3D context embeddings from LiDAR. Both map elements and LiDAR embeddings can be processed into sets of tokens at several granular levels for better context learning. Next, agent embeddings and multi-granular context embeddings can be passed through a Transformer encoder after being filtered by our motion-aware context search for better efficiency. Then, motion predictions can be generated through iterative refinement within the decoder and modeled by Gaussian Mixture Model (GMM). Thus, the Transformer-based motion prediction method utilizes multimodal and multi-granular inputs, with motion-aware context search mechanism to enhance accuracy and efficiency; and LiDAR inputs can be incorporated practically and efficiently for the purpose of motion prediction.

### (ii). Method

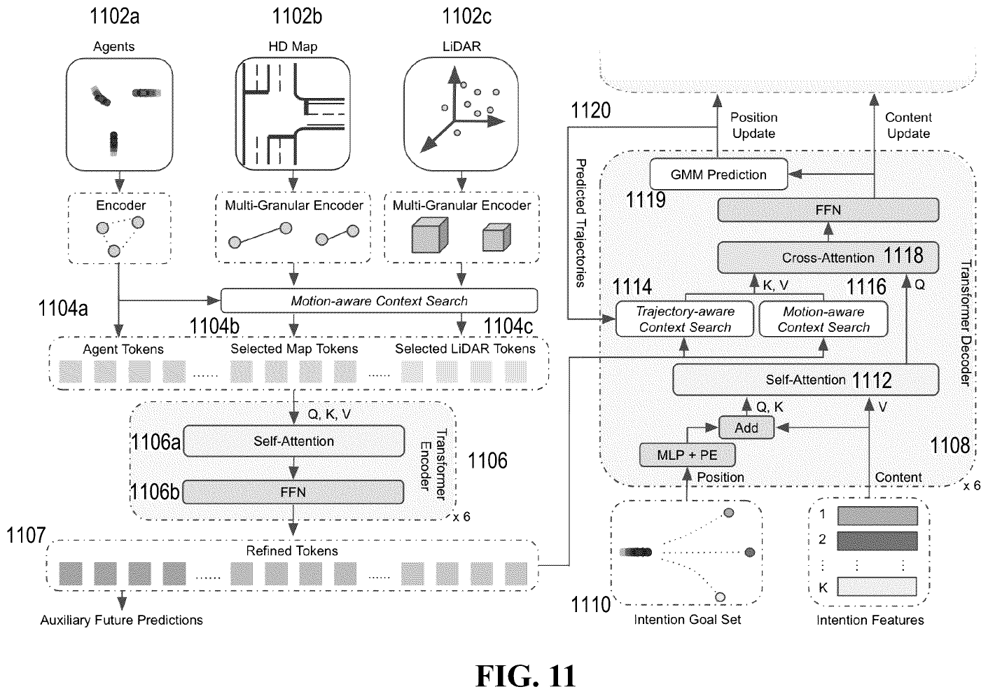

FIG. 11 shows an example MGTR model that can take multimodal inputs in a multi-granular manner, e.g., including LiDAR data. In FIG. 11, agent trajectories 1102 and map elements 1104 are represented as polylines and encoded as agent tokens 1104a and multi-granular map tokens 1104b. LiDAR data 1102c is processed by a pre-trained model into voxel features and further transformed into multi-granular LiDAR tokens 1104c. Motion-aware context search selects a set of map and LiDAR tokens, refined together with agent tokens through local self-attention in the Transformer encoder 1106. Finally, a set of intention goals and their corresponding content features are sent to the decoder 1108 to aggregate context features. Multiple future trajectories of each agent can be predicted based on its intention goals, supporting the multimodal nature of agent behaviors.

Section (ii).A below first describes how different inputs can be represented and encoded into multi-granular tokens and how the number of tokens can be reduced by motion-aware context search. Next, Sections (ii).B and (ii).C describes how tokens can be refined in the encoder and utilized in the decoder for motion prediction. Finally, Section (ii).D introduces the training losses used in the example model.

### (ii).A. Multimodal Multi-Granular Inputs

1) Agent and map 1102a-1102b: Agent state history can be sampled at a constant time interval and processed into vectorized polylines as P_{A}∈□^{N}^{ₐ}^{×T}^{ₕ}^{×C}^{ₐ} to represent state information from T₀-Tₕ to T₀, where Nₐ denotes the number of target agents in a scene, Cₐ as the dimension of agent features, T₀ as the current time, Tₕ as the time horizon. The agent state features Cₐ can include position, velocity, 3D bounding box size, heading angle, object type, etc. Zero paddings are added in the time dimension if the tracking length is smaller than Tₕ. Then, each agent polyline can first be transformed into the target agent-centric coordinate followed by a PointNet-like polyline encoder as shown in Equation (1) below.

Different types of agents can have different movement ranges and requirements for map granularity. Map contents can be extracted a multi-granular manner. Map elements with topological relationships such as road centerlines and area boundaries can be sampled evenly at different sample rates, resulting in polylines with different granularities. Sets of multi-granular polylines can be represented as

$$\{ {P}_{M}^{( i )} \} ∈ {▯}^{{N}_{m}^{( i )} \times {N}_{s}^{( i )} \times {C}_{m}} ,$$

where P_{M}⁽ⁱ⁾ denotes map polylines at i-th spatial granularity, Nₘ⁽ⁱ⁾ denotes the number of polylines at i-th granularity, Nₛ⁽ⁱ⁾ denotes the number of sampled points in each polyline, Cₘ denotes the token feature dimension for map including positions, curvature, speed limit, etc. With a high sample rate, the same road centerline can be sampled into more polylines similar to more image pixels on high-resolution images. Nₘ⁽ⁱ⁾ polylines are generated at each sample rate rᵢ. Similar to agent polylines, each map polyline can be transformed to an agent-centric coordinate and encoded by a PointNet-like structure as:

$${F}_{A} = ϕ ( M L P ( Γ ( {P}_{A} ) ) ) , {F}_{M}^{( i )} = ϕ ( M L P ( Γ ( {P}_{M}^{( i )} ) ) ) , \qquad ( 1 )$$

where Γ(⋅) denotes the coordinate transformation, MLP(⋅) denotes a multi-layer perceptron, ϕ denotes max-pooling. Agent and map polylines are encoded into F_{A}∈□^{N}^{ₐ}^{×C} and

$${F}_{M}^{( i )} ∈ {▯}^{{N}_{m}^{( i )} \times C}$$

with a feature dimension of C. The weights of the polyline encoders for different granularities may not be shared so that map features at each granularity can be kept.

2) LiDAR 1102c: In order to obtain richer 3D context information missing in explicit perception outputs and pre-built HD maps, LiDAR information can be integrated into the framework proposed in this patent document. Using raw LiDAR point cloud directly in the motion prediction network can be inefficient and resource-intensive, due to its sparsity and large magnitude. Therefore, LiDAR voxel features extracted by an LiDAR segmentation network can be used. This may not add additional overhead to autonomous driving systems since most deployed systems have such network already implemented. Although MGTR is not restricted to a certain LiDAR module, a voxel-based segmentation network is adopted, specifically LiDAR-based multi-task network (LidarMultiNet) is an example pre-trained LiDAR model further described in this patent document. A voxel feature map V_{raw}∈□^{C}^{ₗ}^{×D×H×W} can be extracted from an intermediate layer, where Cₗ denotes the feature dimension, D, H, W are the sizes of the voxel space. It serves as an input feature to represent context information for motion prediction. To add more context information, one-hot embedding of the predicted semantic label of each voxel from the segmentation result is concatenated with the 3D position of the center of each voxel with Cₗ LiDAR segmentation features. The voxel feature becomes V∈□^{C}^{ᵥ}^{×D×H×W}, where Cᵥ is the LiDAR feature dimension after concatenation.

To obtain LiDAR context features in multi-granularities and reduce complexity, average pooling across various scales can be used to obtain features of different granularities. Pooled features are encoded into tokens through an MLP as:

$${F}_{L}^{( i )} = M L P ( {P}^{( i )} ( Γ ( V ) ) ) , \qquad ( 2 )$$

where Γ(⋅) denotes the coordinate transformation, P⁽ⁱ⁾(⋅) denotes the average pooling for the i-th granularity. LiDAR features are encoded into F_{L}⁽ⁱ⁾∈□^{N}^{ₗ}^{⁽ⁱ⁾}^{×C}, where Nₗ⁽ⁱ⁾ is the number of LiDAR tokens for the i-th granularity, and C is the feature dimension.

3) Motion-aware context search: After multi-granular encoders, the number of raw tokens N=Nₐ+ΣᵢNₘ⁽ⁱ⁾+ΣᵢNₗ⁽ⁱ⁾ can be extremely large, making it impossible to send them directly to Transformer encoder due to computing resource constraint. To learn features more efficiently, motion-aware context search can be used to help boost training efficiency and encode more meaningful context for agents with different motion patterns. For agents with different velocities, the desired positions of scene context for long-horizon trajectory prediction can differ significantly. Therefore, a current velocity of an agent of interest can be used to project a future distance as the context token search prior. Through the projected position, Ñₘ nearest map tokens and Ñₗ nearest LiDAR tokens is acquired, resulting in a total of Nₐ+Ñₘ+Ñₗ selected tokens that will be fed into our Transformer encoder for further refinement.

### (ii).B. Transformer Encoder 1106

1) Token aggregation and encoding: After the aforementioned vectorization and token generation, a Transformer encoder is established to aggregate features from multi-granular tokens. All tokens can be refined through layers of encoder structure with a self-attention layer 1106a followed by a feed-forward network (FFN) 1106b. To boost training efficiency and better capture neighboring information, a local attention mechanism can be adopted. Let Fₑ^{j} be the refined tokens 1107 output by the j-th layer. The multi-head self-attention can be formulated as:

$$Q = {F}_{e}^{j - 1} + P E ( {F}_{e}^{j - 1} ) , V = κ ( {F}_{e}^{j - 1} ) , \qquad ( 3 )$$

$$K = κ ( {F}_{e}^{j - 1} ) + P E ( κ ( {F}_{e}^{j - 1} ) ) ,$$

$${F}_{e}^{j} = M H S A ( Q , K , V ) ,$$

where κ(⋅) is a function that returns k-nearest neighboring tokens for each query token, PE(⋅) is a positional encoding function. MHSA(⋅,⋅,⋅) stands for multi-head self-attention layer.

2) Future state enhancement: In addition to considering agents' history trajectories, their potential future trajectories can be taken into account to predict the motion of agent of interest. Therefore, after agent tokens are refined by the Transformer encoder, a future trajectory is predicted for each agent and it can be formulated as:

$${T}_{scene} = M L P ( {F}_{e}^{A} ) , \qquad ( 4 )$$

where T_{scene}∈□^{N}^{ₐ}^{×T×4} denotes trajectories (including position and velocity) of Nₐ agent for future T frames and Fₑ^{A} is the agent token from the encoder. The future trajectories are further encoded by a polyline encoder and fused with the original agent token Fₑ^{A} to form a future-aware agent feature that is fed into the decoder later. It's worth noting that T_{scene} is supervised by the ground truth trajectories, resulting in an auxiliary loss which will be introduced in Section (ii).D.

### (ii).C. Transformer Decoder 1108

1) Intention goal set 1110: Generate K representative intention goals by adopting K-means clustering algorithm on endpoints of ground truth trajectories for different types of agents. Each intention goal can represent an implicit motion mode, which can be modeled as a learnable positional embedding.

2) Token aggregation with intention goal set: In each layer, the self-attention module 1112 is first applied to propagate information among K intention queries as follows:

$$Q = K = {F}_{d}^{j - 1} + P E ( {F}_{d}^{j - 1} ) , V = {F}_{d}^{j - 1} , \qquad ( 5 )$$

$${F}_{I}^{j} = M H S A ( Q , K , V ) ,$$

where F_{d}^{j-1}∈ [symbol] ^{K×C}^{_{dec}} are intention features from (j−1)-th decoder layer and F_{I}^{j} is the updated intention feature, where K denotes number of intention goals, C_{dec} denotes feature dimension. The intention features F_{d}⁰ are initialized to be all zeros as the input for the first Transformer decoder. Next, a cross-attention layer 1118 is adopted for aggregating features from the encoder as:

$$Q = {F}_{I}^{j} + P E ( {F}_{I}^{j} ) , \qquad ( 6 )$$

$$K = V = γ ( {F}_{e} ) + P E ( γ ( {F}_{e} ) ) ,$$

$${F}_{d}^{j} = M H C A ( Q , K , V ) , \qquad ( 7 )$$

$$γ ( {F}_{e} ) = η ( {F}_{e} ) ⋃ θ ( {F}_{e} ) ,$$

where F_{I}^{j} is the updated intention feature from previous multi-head self-attention. Fₑ is the multi-granular context tokens from encoder, which includes future-aware agent tokens, map tokens, and LiDAR tokens. MHCA(⋅,⋅,⋅) is the multi-head cross-attention layer. γ(⋅) is the combination of our trajectory-aware context search (η(⋅)) and motion-aware context search 1116 (θ(⋅)), which can extract multi-granular context features from a local region. Trajectory-aware context search 1114 takes the predicted trajectories from previous decoder layer and selects the context token whose centers are close to the predicted trajectory. Along with the previously mentioned motion-aware context search 1116, it can continuously attend to the most important context information throughout iterative prediction refinement.

3) Multimodal motion prediction with GMM 1119: The multimodal future trajectories can be modeled with GMM. For each decoder layer, a classification head and a regression head can be appended for the intention feature F_{d}^{j} respectively:

$$p = M L P ( {F}_{d}^{j} ) , {T}_{target} = M L P ( {F}_{d}^{j} ) , \qquad ( 8 )$$

where p∈□^{K} is the probability distribution of each trajectory mode corresponding to each intention goal. T_{target}∈□^{K×T×7} is predicted GMM parameters representing K future trajectories and 2D velocities for T future frames. The endpoints of predicted trajectories 1120 can be used for positional embedding in the next decoder layer.

### (ii).D. Training Loss

The training loss in this work is a weighted combination of: (i) auxiliary task loss Lₐᵤₓ on future predicted trajectories of all agents T_{scene} (ii) classification loss L_{cls} in form of cross entropy loss on predicted intention probability p (iii) GMM loss L_{GMM} in form of negative log-likelihood loss of the predicted trajectories of target agent T_{target}. Auxiliary task loss is measured with L1 loss between ground truth and predictions of both agents' position and velocity. A hard-assignment strategy can be used to select the best matching mode and calculates the GMM loss and the classification loss. This can force each mode to specialize for a distinct agent behavior.

Thus, the MGTR described in this patent document can incorporate multimodal inputs including LiDAR point cloud in an effective multi-granular manner. Rich context features at different granularities can enhance the overall motion prediction performance.

### 7. EXAMPLES OF LIDAR CONTEXT REPRESENTATION

In some embodiments, a scheme such as LidarMultiNet may be used to extract LiDAR embeddings. For example, this scheme may be trained on Waymo Open Dataset for the 3D object detection/segmentation task. The scheme may use a strong 3D voxel-based encoder-decoder network with an example Global Context Pooling (GCP) module extracting global contextual features from a LiDAR frame to complement its local features. The scheme extracts the embedding features which are used to produce segmentation results in the segmentation heads as the input to the scene encoder of our model. These features effectively encode rich information of objects and context environments from noisy LiDAR points. Some embodiments described herein may use the semantic segmentation, 3D object detection and panoptic segmentation techniques. For example, the encoder-decoder model depicted and described with respect to FIG. 2, including global context pooling (GCP) may be used.

LiDAR-based 3D object detection, semantic segmentation, and panoptic segmentation can be implemented in specialized networks with distinctive architectures that may be difficult to adapt to each other. An example scheme known as LiDAR-based multi-task network (or LidarMultiNet) can unify these three LiDAR perception tasks. Among its many benefits, a multi-task network can reduce the overall cost by sharing weights and computation among multiple tasks. The LidarMultiNet described in this patent document can bridge the performance gap between the multi-task network and multiple single-task networks. The LidarMultiNet may include a 3D voxel-based encoder-decoder architecture with a Global Context Pooling (GCP) module extracting global contextual features from a LiDAR frame. Task-specific heads can be added on top of the network to perform the three LiDAR perception tasks. More tasks can be implemented simply by adding new task-specific heads while introducing little additional cost. A second stage is also proposed to refine the first-stage segmentation and generate accurate panoptic segmentation results.

Given a set of LiDAR point cloud P={pᵢ|pᵢ∈□^{3+c}}ᵢ₌₁^{N}, where N is the number of points and each point has 3+c input features, the goals of the LiDAR object detection, semantic segmentation, and panoptic segmentation tasks can predict the 3D bounding boxes, point-wise semantic labels Lₛₑₘ of K classes, and panoptic labels Lₚₐₙ, respectively. Compared to semantic segmentation, panoptic segmentation additionally requires the points in each instance to have a unique instance identifier (id).

### (i) Example Architecture

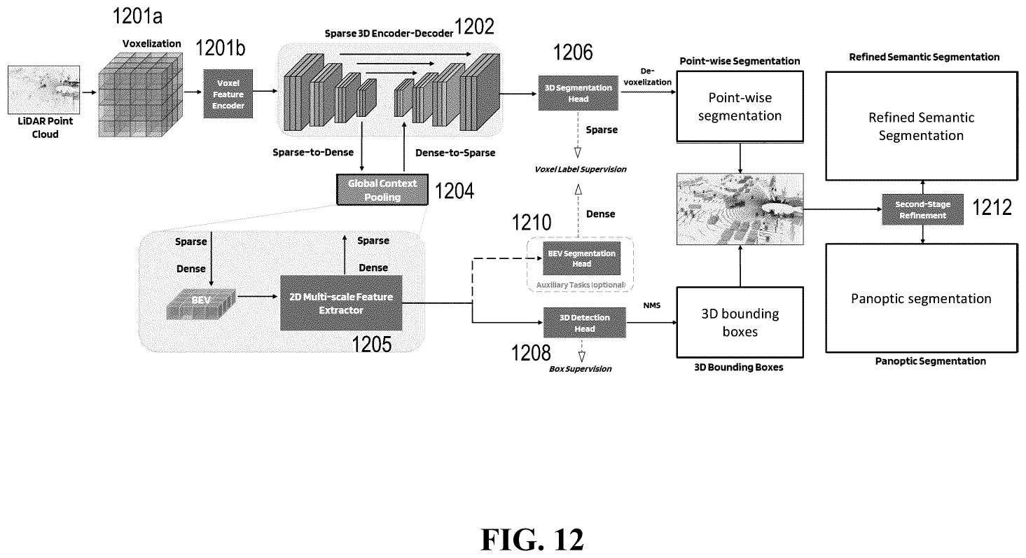

FIG. 12 shown an example main architecture of LidarMultiNet. A voxelization step 1201a converts the original unordered LiDAR points (referred to as LiDAR point cloud in FIG. 12) to a regular voxel grid. A Voxel Feature Encoder (VFE) 1201b consisting of a Multi-Layer Perceptron (MLP) and max pooling layers is applied to generate enhanced sparse voxel features, which serve as the input to the 3D sparse U-Net architecture. Lateral skip-connected features from the encoder can be concatenated with the corresponding voxel features in the decoder. The network includes a 3D encoder-decoder 1202 based on 3D sparse convolution and deconvolutions. A Global Context Pooling (GCP) module 1204 with a 2D multi-scale feature extractor 1205 bridges the last encoder stage and the first decoder stage. In between the encoder and the decoder, a Global Context Pooling (GCP) module 1204 can be applied to extract contextual information through the conversion between sparse and dense feature maps and via a 2D multi-scale feature extractor. 3D segmentation head 1206 is attached to the decoder 1202 and outputs voxel-level predictions, which can be projected back to the point level through the de-voxelization step. Heads of BEV tasks, such as 3D object detection, are attached to the 2D BEV branch. The 3D detection head 1208 and auxiliary BEV segmentation head 1210 are attached to the 2D BEV branch.

The 2nd-stage produces the refined semantic segmentation and the panoptic segmentation results. Given the detection and segmentation results of the first stage, the second stage is applied to refine semantic segmentation and generate panoptic segmentation results.

The 3D encoder 1202 may include four stages of 3D sparse convolutions with increasing channel width. Each stage may start with a sparse convolution layer followed by two submanifold sparse convolution blocks. The first sparse convolution layer can have a stride of two except at the first stage, therefore the spatial resolution can be downsampled by eight times in the encoder. The 3D decoder can also have four symmetrical stages of 3D sparse deconvolution blocks but with decreasing channel width except for the last stage. The same sparse convolution key indices can be used between the encoder and decoder layers to keep the same sparsity of the 3D voxel feature map.

For the 3D object detection task, the detection head of the anchor-free 3D detector CenterPoint can be adopted and attach it to the 2D multi-scale feature extractor. Besides the detection head, an additional BEV segmentation head also can be attached to the 2D branch of the network, providing coarse segmentation results and serving as an auxiliary loss during the training.

### (ii) Global Context Pooling

3D sparse convolution can drastically reduce the memory consumption of the 3D CNN for the LiDAR point cloud data, but it can require the layers of the same scale to retain the same sparsity in both encoder and decoder. This may restrict the network to use only submanifold convolution in the same scale. However, submanifold convolution may not broadcast features to isolated voxels through stacking multiple convolution layers. This can limit the ability of CNN to learn long-range global information. This patent document describes a Global Context Pooling (GCP) module 1204 to extract large-scale information through a dense BEV feature map. GCP can efficiently enlarge the receptive field of the network to learn global contextual information for the segmentation task. The 2D BEV dense feature of the GCP can also be used for 3D object detection or other BEV tasks, by attaching task-specific heads with marginal additional computational cost.

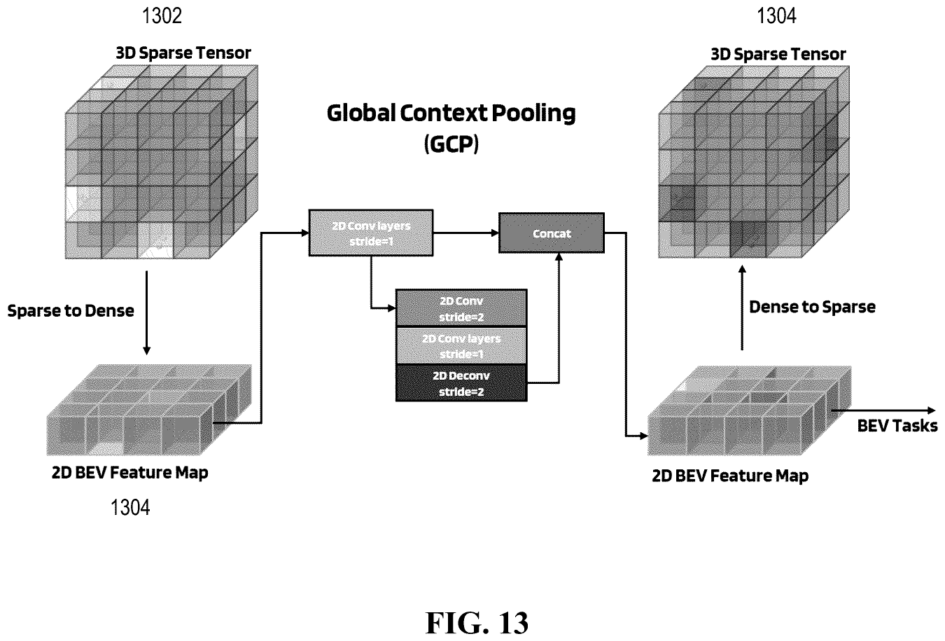

As illustrated in FIG. 13, given the low-resolution feature representation of the encoder output, the sparse voxel feature is first transformed into a dense feature map

$${F}_{encoder}^{sparce} ∈ {□}^{{C}^{′} \times {M}^{′}} \to {F}^{dense} ∈ {□}^{{C}^{′} \times \frac{D}{d 𝓏} \times \frac{H}{dx} \times \frac{W}{dy}} ,$$

where d is the downsampling ratio and M′ is the number of valid voxels in the last scale. The features in different heights together are concatenated to form a 2D BEV feature map

$${F}_{in}^{bev} ∈ {□}^{( {C}^{′} \times \frac{D}{d 𝓏} ) \times \frac{H}{dx} \times \frac{W}{dy}} .$$

Then, a 2D multi-scale CNN is used to further extract long-range contextual information. A deeper and more complex structure can be utilized with a trivial run-time overhead, since the BEV feature map has a relatively small resolution. Lastly, the encoded BEV feature representation can be reshaped to the dense voxel map, then transform it to the sparse voxel feature following the reverse dense to sparse conversion.

FIG. 13 shows an example set of operations associated with a Global Context Pooling (GCP) module 1204. 3D sparse tensor 1302 is projected to a 2D BEV feature map 1304. Two levels of 2D BEV feature maps are concatenated and then converted back to a 3D sparse tensor 1304, which serves as the input to the BEV task heads.

Benefiting from GCP, the example architecture an enlarge the receptive field, which can play an important role in semantic segmentation. In addition, the BEV feature maps in GCP can be shared with other tasks (e.g., object detection) simply by attaching additional heads with slight increase of computational cost. By utilizing the BEV-level training like object detection, GCP can enhance the segmentation performance furthermore.

(iii) Multi-Task Training and Losses

The 3D segmentation branch 1206 can predicts voxel-level labels L^{v}={lⱼ|lⱼ∈(1 . . . . K)}ⱼ₌₁^{M} given the learned voxel features F_{decoder}^{sparse}∈□^{C×M} output by the 3D decoder 1202. M stands for the number of active voxels in the output and C represents the dimension of every output feature. It can be supervised through a combination of cross-entropy loss and Lovasz loss: L_{SEG}=L_{ce}^{v}+L_{Lovasz}^{v}. Note that L_{SEG} is a sparse loss, and the computational cost as well as the GPU memory usage are much smaller than dense loss.

The detection heads can applied on the 2D BEV feature map:

$${F}_{out}^{bev} ∈ {□}^{{C}_{bev} \times \frac{H}{dx} \times \frac{W}{dy}} .$$

They can predict a class-specific heatmap, the object dimensions and orientation, and a IoU rectification score, which are supervised by the focal loss (Lₕₘ) and L1 loss (L_{reg}, Lᵢₒᵤ) respectively: L_{DET}=λₕₘLₕₘ+λ_{reg}L_{reg}+λᵢₒᵤLᵢₒᵤ, where the weights λₕₘ, λ_{reg}, λᵢₒᵤ are empirically set to [1, 2, 1].

During training, the BEV segmentation head can be supervised with L_{BEV}, a dense loss consisting of cross-entropy loss and Lovasz loss: L_{BEV}=L_{ce}^{bev}+L_{Lovasz}^{bev}.

A network can be trained end-to-end for multiple tasks. The weight of each component of the final loss can be described based on the uncertainty as follows:

$${L}_{total} = {\sum }_{{L}_{i} ∈ \{ \begin{matrix}{L}_{ce}^{v} , {L}_{Lovas 𝓏}^{v} , {L}_{ce}^{bev} , \\ {L}_{Lovas 𝓏}^{bev} , {L}_{hm} , {L}_{reg} , {L}_{iou}\end{matrix} \}} \frac{1}{2 {σ}_{i}^{2}} {L}_{i} + \frac{1}{2} log {σ}_{i}^{2} \qquad ( 9 )$$

where σᵢ is the learned parameter representing the degree of uncertainty in taskᵢ. The more uncertain the task; is, the less Lᵢ contributes to Lₜₒₜₐₗ. The second part can be treated as a regularization term for σᵢ during training.

Instead of assigning an uncertainty-based weight to every single loss, the losses belonging to the same task is first grouped with fixed weights. The resulting three task-specific losses (i.e., L_{SEG}, L_{DET}, L_{BEV}) are then combined using weights defined based on the uncertainty:

$${L}_{total} = {\sum }_{i ∈ \{ SEG , DET , BEV \}} \frac{1}{2 {σ}_{i}^{2}} {L}_{i} + \frac{1}{2} log {σ}_{i}^{2} \qquad ( 10 )$$

### Second-Stage Refinement 1212

Coarse panoptic segmentation result can be obtained directly by fusing the first-stage semantic segmentation and object detection results, i.e., assigning a unique ID to the points classified as one of the foreground thing classes within a 3D bounding box. However, the points within a detected bounding box can be misclassified as multiple classes due to the lack of spatial prior knowledge. In order to improve the spatial consistency for the thing classes, point-based approach is described in this patent document as the second stage to refine the first-stage segmentation and provide accurate panoptic segmentation.

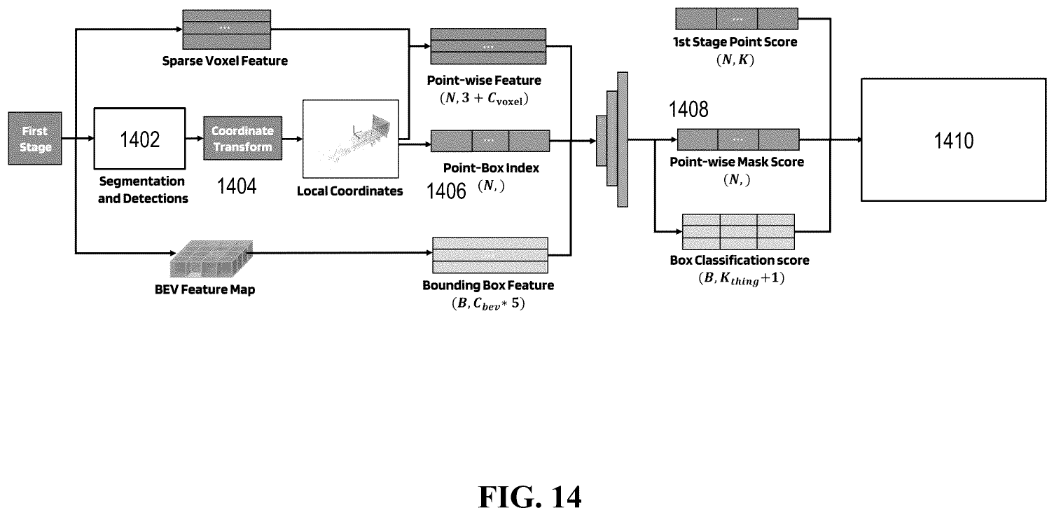

The second stage 1212 is illustrated in FIG. 14. Specifically, it takes features from raw point cloud P, the B predicted bounding boxes, sparse voxel features F_{decoder}^{sparse}, and the BEV feature map Fₒᵤₜ^{bev} to predict box classification scores S_{box} and point-wise mask scores Sₚₒᵢₙₜ. Given the B bounding box predictions in the first stage, each point within a box is first transformed into its local coordinates. Then, its local coordinates are concatenated with the corresponding voxel features from F_{decoder}^{sparse}. Meanwhile, 2nd-stage box-wise features is extracted from F^{bev}. A point-box index I={indᵢ|indᵢ∈I, 0≤indᵢ≤B}ᵢ₌₁^{N} is assigned to the points in each box. The points that are not in any boxes are assigned with index ϕ and will not be refined in the 2nd stage. Next, a PointNet-like network can be used to predict point-wise mask scores Sₚₒᵢₙₜ={spᵢ|spᵢ∈(0,1)}ᵢ₌₁^{N} and box classification scores S_{box}={sbᵢ|sbᵢ∈(0,1)^{K}^{_{thing}}⁺¹}ᵢ₌₁^{B}, where K_{thing} denotes the number of thing classes and the one additional class represents the remaining stuff classes Ø. During training, the box-wise class scores are supervised through a cross-entropy loss and the point-wise mask scores are supervised through a binary cross-entropy loss.

FIG. 14 illustrates an example second-stage refinement pipeline. The architecture of the second-stage refinement is point-based. The detected boxes, voxel-wise features, and BEV features from the first stage are first fused 1402 to generate the inputs 1404 for the second stage. The local coordinate transformation 1404 is applied to the points within each box at 1406. Then, a point-based backbone with MLPs, attention modules, and aggregation modules infer the box classification scores and point-wise mask scores 1408. The final refined segmentation scores 1410 are computed by fusing the first and second stage predictions.

The segmentation consistency of points of the thing objects can be improved by the 2nd stage. The 2nd-stage predictions are merged with the 1st-stage semantic scores to generate the final semantic segmentation predictions \hat{L}ₛₑₘ. To refine segmentation score S_{2nd}={rsᵢ|rsᵢ∈(0,1)^{K}^{_{thing}}⁺¹}ᵢ₌₁^{N}, the point-wise mask scores can be combined with their corresponding box-wise class scores as follows:

$${S}_{2 nd} ( j ) = \{ \begin{matrix}{S}_{point} \times {S}_{box} ( j ) , & j ∈ {I}^{{K}_{thing}} \\ {S}_{point} \times {S}_{box} ( j ) + ( 1 - {S}_{point} ) , & j = ∅\end{matrix} \qquad ( 11 )$$

where K_{thing} denotes the number of thing classes, Ø denotes the rest stuff classes which would not be refined in the 2nd stage, Sₚₒᵢₙₜ={spᵢ|spᵢ∈(0,1)}ᵢ₌₁^{N} is the point-wise mask scores, and S_{box}={sbᵢ|sbᵢ∈(0,1)^{K}^{_{thing}}⁺¹}ᵢ₌₁^{B} is the box classification scores. N and B denote the number of points and boxes.

In addition, the points not in any boxes can be considered as S_{2nd}(Ø)=1, which means their scores are the same as the first stage scores. Then, the refined scores can be further combined with the first stage scores as follows:

$${S}_{final} = \{ \begin{matrix}{S}_{1 st} \times {S}_{2 nd} ( ∅ ) + {S}_{2 nd} \text{(*} ) , & {ind}_{i} \neq ϕ , * \neq ∅ \\ {S}_{1 st} , & {ind}_{i} \neq ϕ\end{matrix} \qquad ( 12 )$$

where ϕ denotes the index where points are not in any boxes, and S₁ₛₜ={sfᵢ|sfᵢ∈(0,1)^{K}}ᵢ₌₁^{N} is the first stage scores.

The scores S_{final} are used to generate the semantic segmentation results \hat{L}ₛₑₘ through finding the class with the maximum score. The final panoptic segmentation results can be inferred through the first stage boxes and the final semantic segmentation results S_{box} and \hat{L}ₛₑₘ. First, points for a box where points and the box have the same semantic category are extracted. Then the extracted points will be assigned a unique index as the instance id for the panoptic segmentation.

### 8. EXAMPLES OF USING RASTERIZED REPRESENTATION IN THE TRANSFORMER-BASED PREDICTION ARCHITECTURE

Current transformer based prediction architectures are mostly based on vectorized representation instead of rasterized representation. The limitation for this method is that it requires multiple attention layers to learn the relationship between the agent and the map polylines. Rasterized image representation can take advantage of the powerful convolutional neural network (CNN) and encode such relationships in a simple way.

One main benefit of using a rasterized top-down input representation is the simplicity to encode spatial information such as semantic road information and traffic lights, which are crucial for human driving. Various embodiments described in the present document provide examples of how a rasterized representation may be used for scene encoder. For example, raw sensor data may be input in a rasterized format to the scene encoder, as described in these embodiments.

### 9. ADDITIONAL EXAMPLE EMBODIMENTS

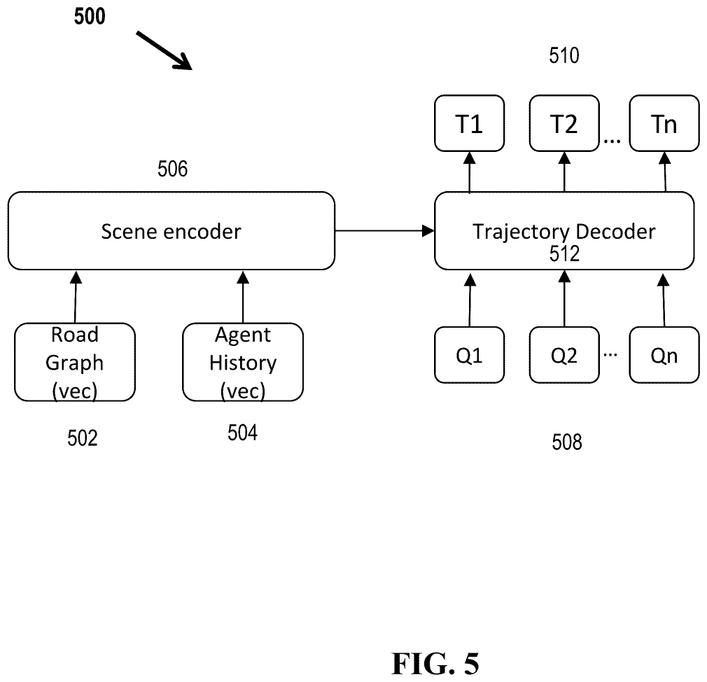

FIG. 5 depicts an example embodiment of trajectory prediction in which a scene encoder 506 receives a vectorized representation of a road graph 502 and a vectorized history of vehicles (504). The output of the scene encoder 506 is provided to a trajectory decoder 512. A number n of queries 508 may be provided to the trajectory decoder, producing n number of trajectories 510. In a typical implementation, between 3 to 8 queries may be used (e.g., pedestrian, 4-wheel vehicle, 2-wheel vehicle, etc.). As previously disclosed, such an implementation may provide a limited performance due to the encoder not being able to capture finer details of the environment of a vehicle.

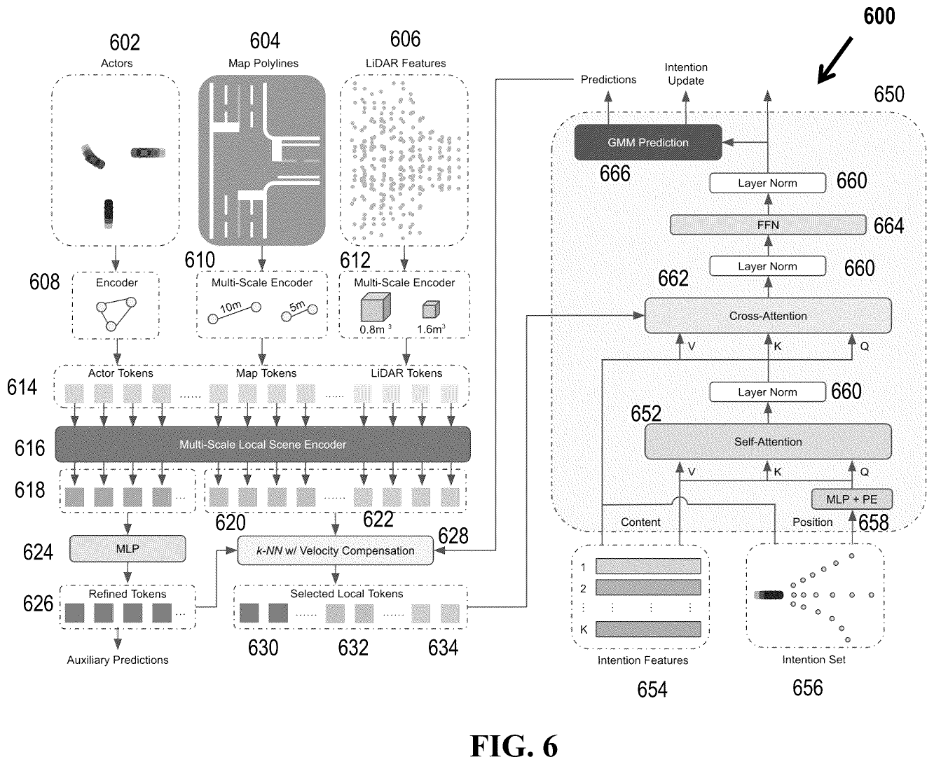

FIG. 6 depicts a trajectory detection workflow 600 in which the following features may be incorporated.

The workflow 600 may receive three different types of inputs, including at least two different representation types. For example, various actors (e.g., other vehicles near a target vehicle) may be input using a rasterized representation 602. Another input may include map polylines 604 and in general a vectorized input of surrounding area of the target vehicle. Yet another input includes raw data from a vehicle-mounted sensor. For example, lidar or camera image data may be used. In FIG. 6, the third input is lidar point cloud information 606.

The workflow 600 may process each received information to generate various tokens. For example, the actor information 602 may be processed through an encoder 608 to generate actor tokens (614). For example, actor tokens may be represented as bounding boxes. The workflow 600 may process the vectorized map input using an encoder 610 and generate map tokens. In some embodiments, a multi-scale encoding strategy may be used by the encoder 610, as described in the present document.

The workflow 600 may process the raw data obtained from lidar using an encoder 612 and generate point cloud, or lidar, tokens. In some embodiments, the encoder 612 may use multi-scale (or multi-grain) encoding, as described in the present document. The various tokens 614 may be processed using a local scene encoder 616. As previously mentioned, in some embodiments, a multi-scale strategy may be used by the local scene encoder 616.

The local scene encoder 616 may produce, as its outputs, encoded tokens 618, 620, 622, corresponding to information from the actors, map, and raw sensor data. Next, a multi-layer perceptron (MLP) 624 may be used to further refine the tokens 618 to generate refined tokens 626.

The output tokens 618, 620, 622 of the scene encoder may be processed by a neural network (NN) stage 628 that may identify k nearest neighbors of the target vehicle (e.g., using k-NN algorithm). Here, velocity compensation may be used to help identify nearest neighbors. Typically, zero to 64 nearest neighbors may be identified by the workflow 600. The resulting selected local tokens are represented as 630, 632, 634, deriving from nearby objects, map data and raw sensor data, respectively. The NN state 628 may also use inputs from predicted trajectories from a previous iteration of the decoder (e.g., object velocities) as its inputs for the identification of nearest neighbors.

The decoder-side 650 may comprise a self-attention layer 652 that receives intention features 654 and an intension set 656 (which may be refined through an MLP and position estimate (PE) layer 658). The inputs provided to the self-attention layer 652 include V, K and Q parameters, as described herein. An optional layer normalization 660 may be performed on the output of the self-attention results, followed by a cross-attention layer 662 which performs decoding based on a cross-attention with the local tokens selected at output of 628. The output may be processed through another layer normalization stage 660 and a feed-forward network FFN 664. Outputs of the FFN 664 may be normalized using layer normalization 660, and a gaussian mixture model GMM prediction stage 666 to output trajectory predictions. Also, intention updates may be output by the GMM prediction stage 666.

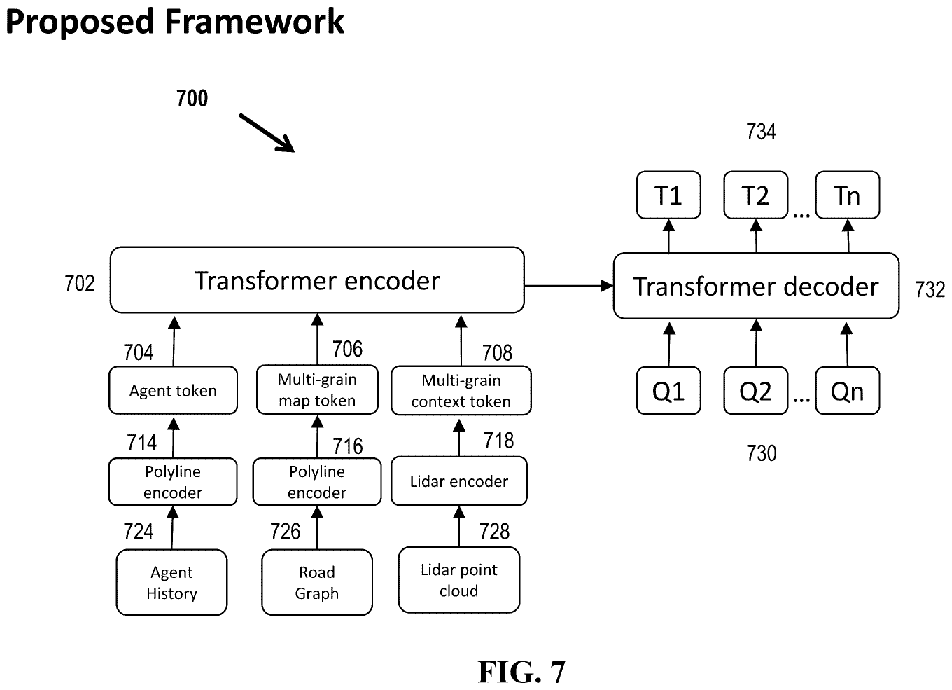

FIG. 7 is a block diagram of another embodiment 700 showing functional blocks similar to the previous description of FIG. 6. The transformer encoder 702 receives three inputs-agent tokens 704, multi-grain (or multi-scale) map tokens 706 and multi-grain context tokens 708. Agent tokens 704 may be similar to the previously discussed actor tokens 614. The agent tokens 704 may be output of a polyline encoder 714 that encodes agent history 724 information (see, e.g., 602 and 608).

Multi-grain map tokens 706 may be similar to map tokens described with reference to FIG. 6 and may be output of a polyline encoder 716 that works with road map/road graph information 726.

Multi-grain context tokens 708 may be derived from output of a lidar encoder 718 that uses lidar point cloud data 728 received from onboard lidars.

A decoder 732 may operate on the output of the transformer encoder 702 using queries 730 Q1 . . . . Qn to produce trajectory estimates 734 T1 . . . . Tn. The number n of trajectory estimates may typically be 8 or fewer.

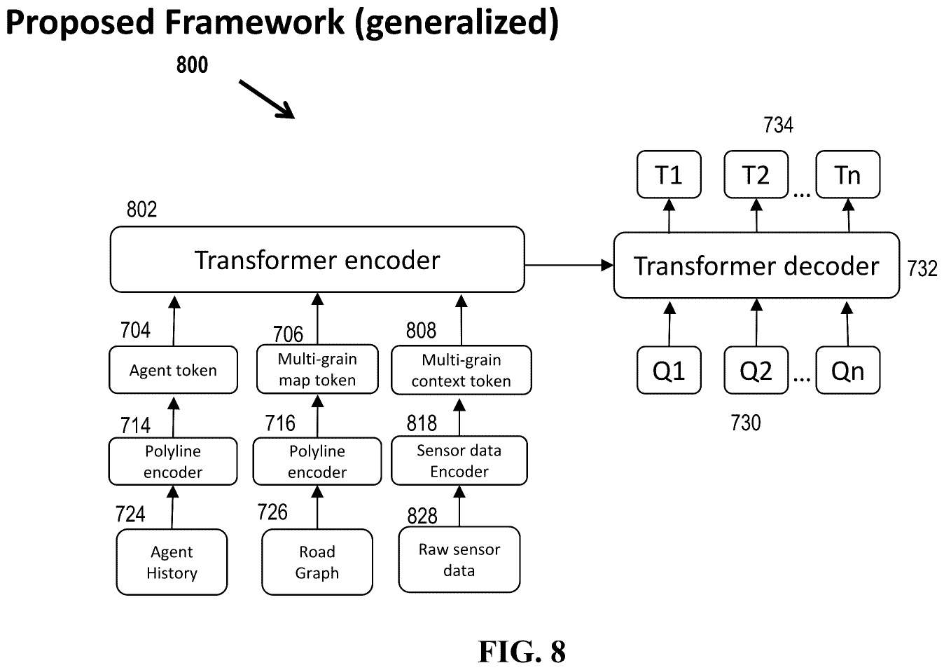

FIG. 8 shows another framework 800 for operation of transformer based encoder-decoder configuration for trajectory prediction. Compared to FIG. 7, in this embodiment, raw sensor data 828 from another (e.g., a non-lidar) sensor may be used to perform sensor data encoding 818 to produce multi-grain context tokens 808. For example, digital images captured from a camera may be used.

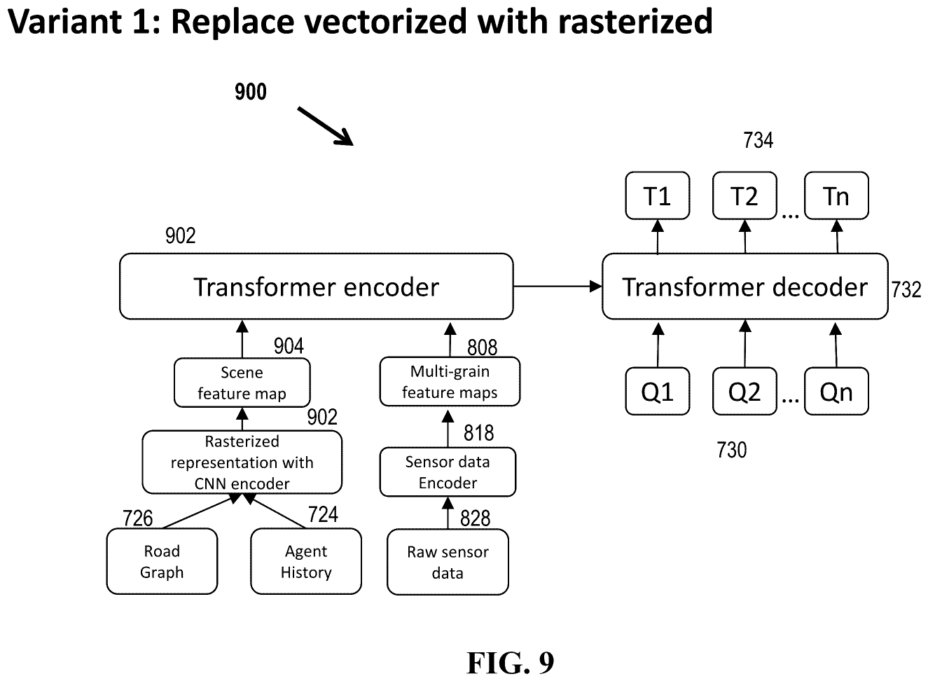

FIG. 9 shows a framework in which, instead of vectorized representations, a rasterized representation is used. For example, the transformer encoder 902 in the framework 900 operates on a multi-grain feature map 808 (e.g., previously described with respect to FIG. 8), and a scene feature map 904 that is derived from a rasterized representation obtained from a convolutional neural network (CNN) 902 using agent history 724 and road graph 726. The remaining details are described with respect to like numerals in FIG. 8.

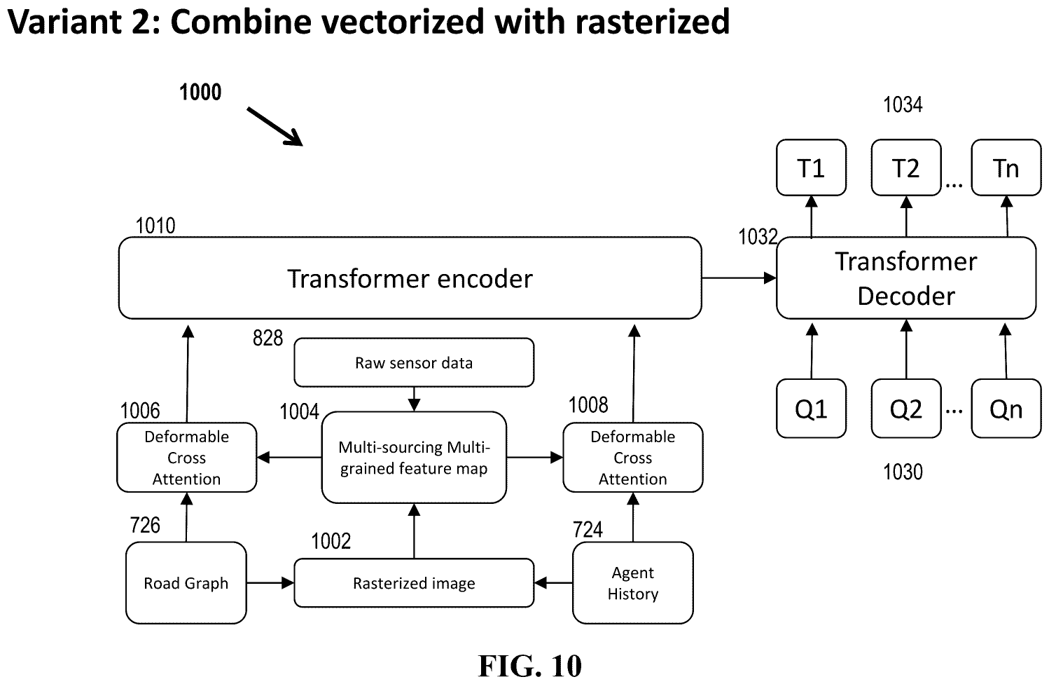

FIG. 10 shows example of a framework 1000 that uses a combination of vectorized and rasterized data. Road graph 726 and agent history 724 may be used to generate a rasterized image 1002. An output of the rasterized image stage 1002 may be processed along with raw sensor data 828 by a multi-source multi-grain feature map encoder 1004. Cross-attention between an output of the feature map encoder 1004 and the road graph 726 may be generated by a cross-attention stage 1006 as one input to a transformed encoder 1010. A cross-attention between the output of the feature map encoder 1004 and agent history 724 may be encoded using a stage 1008, which provides a second input to the transformed encoder 1010. On the decoder side, a transformer decoder 1032 may operate on queries 1030 and produce trajectory estimates 1034, in a similar manner described with respect to FIGS. 6 to 9.

### 10. EXAMPLES OF TECHNICAL SOLUTIONS

Below is a listing of various technical solutions adopted by some preferred embodiments.

1. A computer-implemented method of trajectory prediction, comprising: determining a first cross-attention between a vectorized representation (e.g., a first vectorized representation) of a road map near a vehicle and information obtained from a rasterized representation of an environment near the vehicle by processing through a first cross-attention stage; determining a second cross-attention between a vectorized representation (e.g., a second vectorized representation) of a vehicle history and information obtained from the rasterized representation by processing through a second cross-attention stage; operating a scene encoder on the first cross-attention and the second cross-attention; operating a trajectory decoder on an output of the scene encoder; generating one or more trajectory predictions by performing one or more queries on the trajectory decoder.

2. The method of solution 1, wherein the information obtained from the rasterized representation comprises a multi-sourced, multi-grained feature map.

3. The method of solution 2, wherein the information is further based on a lidar point cloud obtained from a sensor located on the vehicle.

4. The method of any of solutions 1-3, wherein the rasterized representation comprises traffic signal information near the vehicle.

5. The method of any of solutions 1-3, wherein the information comprises a raw camera image obtained by a camera on the vehicle.

6. The method of any of solutions 1-5, wherein the scene encoder comprises N encoding layers, where N is a positive integer.

7. The method of any of above solutions, wherein the trajectory decoder comprises M encoding layers, where N is a positive integer.

8. The method of any of above solutions, wherein the generating the one or more trajectory predictions includes generating a probability associated with each trajectory prediction.

9. The method of solution 8, wherein a Gaussian mixture model is used for generating the probability associated with each trajectory prediction.

10. The method of any of above solutions, wherein the scene encoder generates at least one token used for a query that is responsive to a pedestrian pose or a pedestrian gaze.

Some embodiments may advantageously use raw sensor data in determination of tokens and queries, as below.

11. A computer-implemented method of trajectory prediction, comprising: generating one or more predicted trajectories by operating an encoder-decoder combination, wherein the encoder is configured to: receive a rasterized representation of an environment, a vectorized representation of the environment and a raw sensor data representation of the environment; generate tokens by processing the rasterized representation, the vectorized representation and the raw sensor data representation with a scene encoder; and the decoder is configured to: determine the one or more predicted trajectories by processing the tones through one or more layers of neural network processing.

12. The method of solution 11, wherein the raw sensor data comprises point cloud data obtained from a lidar.

13. The method of solution 11, wherein the raw sensor data comprises camera images obtained from a camera.

14. The method of any of above solutions, wherein the encoder is configured to generate the tokens by performing velocity compensation of a set of tokens generated based on a history data of agents operating in the environment.

15. The method of any of above solutions, wherein the raw sensor data is processed through a multi-scale encoder stage in which a plurality of dimensions are used by the multi-scale encoder to generate a plurality of tokens corresponding to object features identified from the raw sensor data.

16. The method of solution 15, wherein the raw sensor data comprises the point cloud data and wherein the plurality of dimensions includes a first voxel dimension having a size smaller than or equal to a human object and a second voxel dimension having a size smaller than or equal to an automobile dimension.

17. The method of solution 16, wherein the plurality of tokens is refined by performing a velocity compensation, wherein the velocity compensation uses velocity estimates obtained from previously made trajectory predictions.

18. The method of any of above solutions, wherein the generating the one or more trajectory predictions includes generating a probability associated with each trajectory prediction.

19. The method of solution 8, wherein a Gaussian mixture model is used for generating the probability associated with each trajectory prediction.

20. The method of any of above solutions, wherein the scene encoder generates at least one token used for a query that is responsive to a pedestrian pose or a pedestrian gaze.

Some preferred embodiments may incorporate multi-scale, multi-resolution processing as below.

21. A computer-implemented method of trajectory prediction, comprising: generating a plurality of multi-scale vectorized representations of an environment in which a vehicle is operating; generating a plurality of multi-scale raw sensor data representations of the environment, wherein the raw sensor data is from one or more sensors disposed on the vehicle; operating a neural network encoder-neural network decoder cascade in which the plurality of multi-scale vectorized representation and the plurality of multi-scale raw sensor data are processed to generate tokens that are passed from the neural network encoder to the neural network decoder and one or more trajectory predictions are output from the neural network decoder based on one or more queries.

22. The method of solution 21, wherein the multi-scale vectorized representations comprise a first dimension having a size less than or equal to a passenger vehicle size and a second dimension having a size less than or equal to a commercial vehicle size.

23. The method of any of above solutions, wherein the raw sensor data comprises point cloud data or camera image data.

24. The method of any of above solutions, wherein the neural network encoder comprises a velocity compensating encoder layer.

25. The method of any of above solutions, wherein the neural network encoder is configured to generate the tokens by performing velocity compensation of a set of tokens generated based on a history data of agents operating in the environment.

26. The method of any of above solutions, wherein the raw sensor data is processed through a multi-scale encoder stage in which a plurality of dimensions are used by the multi-scale encoder to generate a plurality of tokens corresponding to object features identified from the raw sensor data.

27. The method of solution 26, wherein the raw sensor data comprises the point cloud data and wherein the plurality of dimensions includes a first voxel dimension having a size smaller than or equal to a human object and a second voxel dimension having a size smaller than or equal to an automobile dimension.

28. The method of any of above solutions, wherein the generating the one or more trajectory predictions includes generating a probability associated with each trajectory prediction.

29. The method of solution 8, wherein a Gaussian mixture model is used for generating the probability associated with each trajectory prediction.

30. The method of any of above solutions, wherein the scene encoder generates at least one token used for a query that is responsive to a pedestrian pose or a pedestrian gaze.

31. An autonomous vehicle comprising one or more processors configured to implement a method recited in any of solutions 1-30.

32. An apparatus comprising one or more processors configured to implement a method recited in any of solutions 1-30.

33. A computer-storage medium having process-executable code that, upon execution, causes one or more processor to implement a method recited in any of solutions 1-30.

A multi-granularity framework, called multi-Granularity Transformers framework (MGTR) exploits context features in different granularities using a framework that is similar in many aspects to the framework described with respect to FIG. 6 of this patent document.

### 11. FINAL REMARKS

Motion prediction is one of the technical components in the autonomous driving system to handle uncertain and complex scenarios involving moving agents of different types. The present document discloses some embodiments, called a multi-Granularity TRansformers (MGTR) framework, an encoder-decoder neural network that exploits context features in multi-granularity suitable for a variety of agents. To further boost MGTR's capacity, embodiments exploit 3D context features based on Lidar cloud points and segmentation frameworks which are easily accessible in the onboard autonomous driving system as the motion forecasting upstream module.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A computer-implemented method of trajectory prediction, comprising:
determining a first cross-attention between a vectorized representation of a road map near a vehicle and information obtained from a rasterized representation of an environment near the vehicle by processing through a first cross-attention stage;
determining a second cross-attention between a vectorized representation of a vehicle history and information obtained from the rasterized representation by processing through a second cross-attention stage;
operating a scene encoder on the first cross-attention and the second cross-attention;
operating a trajectory decoder on an output of the scene encoder;
generating one or more trajectory predictions by performing one or more queries on the trajectory decoder.

2. The computer-implemented method of claim 1, wherein the information obtained from the rasterized representation comprises a multi-sourced, multi-grained feature map.

3. The computer-implemented method of claim 2, wherein the information is further based on a lidar point cloud obtained from a sensor located on the vehicle.

4. The computer-implemented method of claim 1, wherein the rasterized representation comprises traffic signal information near the vehicle.

5. The computer-implemented method of claim 1, wherein the information comprises a raw camera image obtained by a camera on the vehicle.

6. The computer-implemented method of claim 1, wherein the scene encoder comprises N encoding layers, where N is a positive integer.

7. The computer-implemented method of claim 1, wherein the trajectory decoder comprises M encoding layers, where N is a positive integer.

8. The computer-implemented method of claim 1, wherein the generating the one or more trajectory predictions includes generating a probability associated with each trajectory prediction.

9. The computer-implemented method of claim 8, wherein a Gaussian mixture model is used for generating the probability associated with each trajectory prediction.

10. The computer-implemented method of claim 1, wherein the scene encoder generates at least one token used for a query that is responsive to a pedestrian pose or a pedestrian gaze.

11. An apparatus comprising one or more processors configured to implement a method, the processor configured to:
determine a first cross-attention between a vectorized representation of a road map near a vehicle and information obtained from a rasterized representation of an environment near the vehicle by processing through a first cross-attention stage;
determine a second cross-attention between a vectorized representation of a vehicle history and information obtained from the rasterized representation by processing through a second cross-attention stage;
operate a scene encoder on the first cross-attention and the second cross-attention;
operate a trajectory decoder on an output of the scene encoder;
generate one or more trajectory predictions by performing one or more queries on the trajectory decoder.

12. The apparatus of claim 11, wherein the information obtained from the rasterized representation comprises a multi-sourced, multi-grained feature map.

13. The apparatus of claim 12, wherein the information is further based on a lidar point cloud obtained from a sensor located on the vehicle.

14. The apparatus of claim 11, wherein the rasterized representation comprises traffic signal information near the vehicle.

15. The apparatus of claim 11, wherein the information comprises a raw camera image obtained by a camera on the vehicle.

16. A non-transitory computer-storage medium having process-executable code that, upon execution, causes one or more processor to implement a method, comprising:
determining a first cross-attention between a vectorized representation of a road map near a vehicle and information obtained from a rasterized representation of an environment near the vehicle by processing through a first cross-attention stage;
determining a second cross-attention between a vectorized representation of a vehicle history and information obtained from the rasterized representation by processing through a second cross-attention stage;
operating a scene encoder on the first cross-attention and the second cross-attention;
operating a trajectory decoder on an output of the scene encoder;
generating one or more trajectory predictions by performing one or more queries on the trajectory decoder.

17. The non-transitory computer-storage medium of claim 16, wherein the scene encoder comprises N encoding layers, where N is a positive integer.

18. The non-transitory computer-storage medium of claim 16, wherein the trajectory decoder comprises M encoding layers, where N is a positive integer.

19. The non-transitory computer-storage medium of claim 16, wherein the generating the one or more trajectory predictions includes generating a probability associated with each trajectory prediction.

20. The non-transitory computer-storage medium of claim 19, wherein a Gaussian mixture model is used for generating the probability associated with each trajectory prediction.
